(19) United States
(12) Patent Application Publication
(10) Pub. No.: US 2017/0279662 A1
(43) Pub. Date: Sep. 28, 2017

(54) COMMUNICATION DEVICE AND COMMUNICATION METHOD

(71) Applicant: FUJI XEROX CO., LTD., Tokyo (JP)

(72) Inventors: Tomoya ISHIZAKI, Kanagawa (JP); Hiroki OHSAWA, Kanagawa (JP)

(73) Assignee: FUJI XEROX CO., LTD., Tokyo (JP)

(21) Appl. No.: 15/217,244

(22) Filed: Jul. 22, 2016

(30) Foreign Application Priority Data
Mar. 22, 2016 (JP) 2016-056393

(51) Int. Cl. H04L 12/24; H04L 5/00; G06F 13/42; H04L 12/26

(52) U.S. Cl. CPC H04L 41/0654; H04L 43/08; H04L 41/12; H04L 41/0677; H04L 5/0055; G06F 13/4282

(57) ABSTRACT

A communication device includes multiple communication terminals, a communication unit, an abnormality identification unit, and a communication controller. The communication terminals are connected to a different communication device. The communication unit performs communication with the different communication device via the communication terminals, and the communication unit uses multiple communication settings each of which differently uses at least one of the communication terminals in the communication. The abnormality identification unit identifies at least one of the multiple communication terminals that is abnormal in the communication. The communication controller causes the communication unit to perform the communication by using one of the communication settings that uses at least one of the multiple communication terminals other than the at least one communication terminal identified by the abnormality identification unit.

### CROSS-REFERENCE TO RELATED APPLICATIONS

This application is based on and claims priority under 35 USC 119 from Japanese Patent Application No. 2016-056393 filed Mar. 22, 2016.

### BACKGROUND

(i) Technical Field

The present invention relates to a communication device and a communication method.

(ii) Related Art

To date, serial communication based on a serial peripheral interface (SPI) system has been performed between a central processing unit (CPU) and a peripheral device. Each of these devices functions as a sort of communication device. A known SPI communication circuit includes multiple communication terminals, and the use of the multiple communication terminals allows simultaneous communications via the communication terminals and thus increases the communication speed.

### SUMMARY

According to an aspect of the invention, there is provided a communication device including multiple communication terminals, a communication unit, an abnormality identification unit, and a communication controller. The communication terminals are connected to a different communication device. The communication unit performs communication with the different communication device via the communication terminals, and the communication unit uses multiple communication settings each of which differently uses at least one of the communication terminals in the communication. The abnormality identification unit identifies at least one of the multiple communication terminals that is abnormal in the communication. The communication controller causes the communication unit to perform the communication by using one of the communication settings that uses at least one of the multiple communication terminals other than the at least one communication terminal identified by the abnormality identification unit.

### BRIEF DESCRIPTION OF THE DRAWINGS

Exemplary embodiments of the present invention will be described in detail based on the following figures, wherein:

FIG. 1 is a diagram schematically illustrating the configuration of a communication system including a communication device according to a first exemplary embodiment;

FIG. 2 is a list illustrating commands used by the communication system illustrated in FIG. 1;

FIG. 3 is a flowchart illustrating operations performed when communication is abnormal;

FIGS. 4A and 4B each illustrate a first stage of a flowchart illustrating process operations in an abnormal-terminal identification process;

FIG. 5 illustrates a second stage of the flowchart illustrating the process operations in the abnormal-terminal identification process;

FIG. 6 illustrates a third stage of the flowchart illustrating the process operations in the abnormal-terminal identification process;

FIG. 7 illustrates a fourth stage of the flowchart illustrating the process operations in the abnormal-terminal identification process;

FIG. 8 is a diagram schematically illustrating the configuration of a communication system including a communication device according to a second exemplary embodiment;

FIG. 9 is a flowchart illustrating operation steps in an abnormality judgment sequence;

FIG. 10 is a flowchart illustrating operation steps in a D1-D3 terminal judgment sequence; and

FIG. 11 is a timing chart illustrating example operation timing in the D1-D3 terminal judgment sequence.

### DETAILED DESCRIPTION

Exemplary embodiments will be described with reference the drawings.

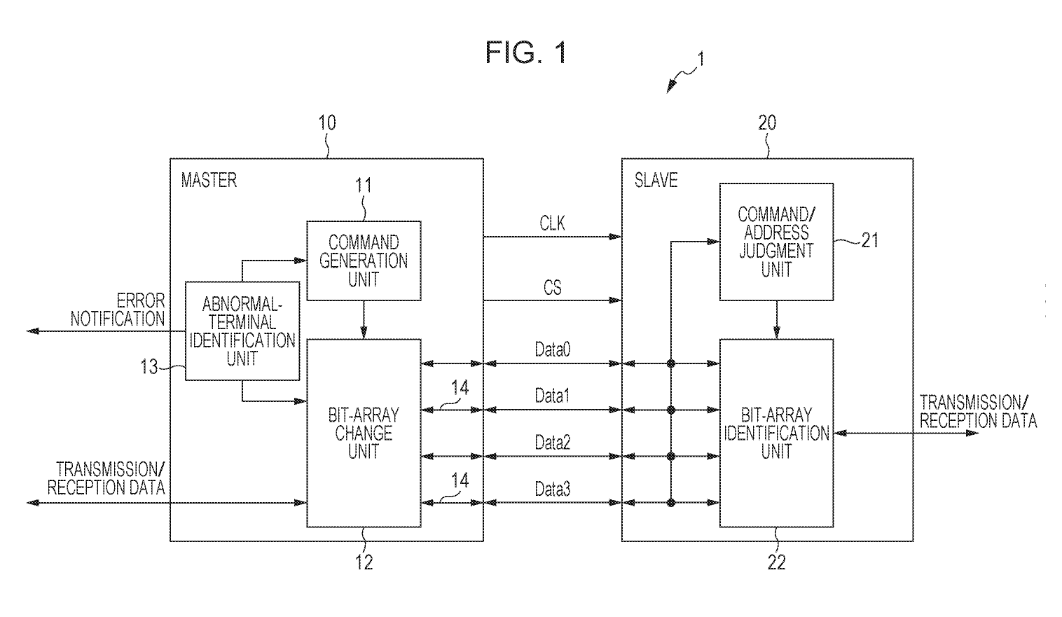

FIG. 1 is a diagram schematically illustrating the configuration of a communication system 1 including a communication device according to a first exemplary embodiment.

The communication system 1 performs SPI communication. The communication system 1 includes a master circuit 10 and a slave circuit 20. The master circuit 10 includes a command generation unit 11, a bit-array change unit 12, an abnormal-terminal identification unit 13, and multiple (herein four, for example) communication terminals 14. The slave circuit 20 includes a command/address judgment unit 21 and a bit-array identification unit 22.

The communication terminals 14 of the master circuit 10 are connected to the slave circuit 20, and the master circuit 10 communicates with the slave circuit 20 via the communication terminals 14 to exchange commands and data. Although FIG. 1 illustrates the one slave circuit 20, multiple slave circuits 20 may be connected to the one master circuit 10.

The master circuit 10 transmits, to the slave circuit 20, a clock signal CLK for synchronizing communication and a chip select signal CS for selecting one of the slave circuits 20.

The command generation unit 11 of the master circuit 10 generates a command expressing an instruction for communication and inputs the command to the bit-array change unit 12. The bit-array change unit 12 exchanges transmission/reception data with another circuit in a device such as a central processing unit (CPU) including the master circuit 10. The bit-array change unit 12 assigns the transmission/reception data to at least one of the four communication terminals 14 that is used in accordance with the command input from the command generation unit 11. In the SPI standards in the related art, communication for a command and an address is performed by using a Data0 terminal. In contrast, in the communication system 1, the command itself and the address are transmitted to the slave circuit 20 by the bit-array change unit 12 by using at least one of the communication terminals 14 in accordance with the command. In FIG. 1, the command and the address are receivable by the bit-array identification unit 22 in the slave circuit 20 via any one of the four communication terminals 14. Note that an SPI device in the related art may be used as a slave circuit. When needing to be discriminated from each other in the following description, the four communication terminals 14 are referred to as a D0 terminal, a D1 terminal, a D2 terminal, and a D3 terminal.

The combination of the command generation unit 11 of the master circuit 10 and the bit-array change unit 12 corresponds to an example of a communication unit. The four communication terminals 14 each correspond to an example of corresponding one of multiple communication terminals.

Commands used by the communication system 1 will be described.

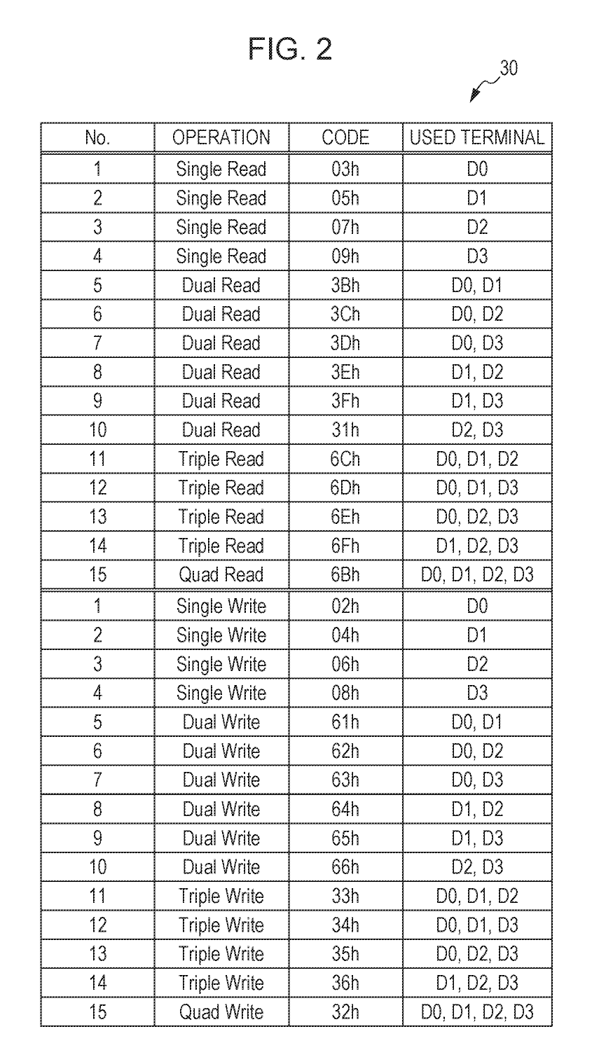

FIG. 2 is a list illustrating commands used by the communication system 1 illustrated in FIG. 1.

A list 30 illustrated in FIG. 2 has No. 1 to 15 commands as commands for reading data (Read; data transfer from the slave circuit 20 to the master circuit 10) and also has No. 1 to 15 commands as commands for writing data (Write; data transfer from the master circuit 10 to the slave circuit 20). A Read command and a Write command that are assigned the same number share one of the communication terminals 14 when communication is performed.

The commands in the list 30 include “Single” commands instructing communication using only one of the communication terminals 14, “Dual” commands instructing communication using two of the communication terminals 14, “Triple” commands instructing communication using three of the communication terminals 14, and “Quad” commands instructing communication using all of the four communication terminals 14.

In the SPI device in the related art, only No. 1, 5, and 15 commands are usable. The usable commands are extended in the first exemplary embodiment.

Referring back to FIG. 1, the description is continued.

As described above, the command generation unit 11 of the master circuit 10 generates a command and inputs the command to the bit-array change unit 12, and the bit-array change unit 12 transmits the command to the slave circuit 20.

In the slave circuit 20, the command/address judgment unit 21 judges the command transmitted from the master circuit 10 to thereby identify the at least one communication terminal 14 used for the communication at this time. The bit-array identification unit 22 in the slave circuit 20 performs communication for transmission/reception data by using the communication terminal 14 in accordance with the command and exchanges the transmission/reception data with another circuit in a device including the slave circuit 20.

When a communication abnormality occurs in the communication between the command generation unit 11 and the bit-array change unit 12, the abnormal-terminal identification unit 13 of the master circuit 10 identifies at least one of the four communication terminals 14 as a communication terminal in an abnormal state that causes the abnormality in the communication. The abnormal-terminal identification unit 13 instructs the command generation unit 11 on communication using the communication terminals 14 other than the at least one identified communication terminal 14. The abnormal-terminal identification unit 13 corresponds to an example of the combination of an abnormality identification unit and a communication controller. Hereinafter, operations in a communication abnormality will be described.

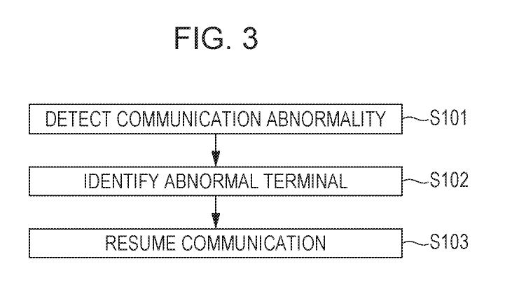

FIG. 3 is a flowchart illustrating operations performed when communication is abnormal.

When a communication abnormality is detected in communication between the command generation unit 11 and the bit-array change unit 12 (step S101), the abnormal-terminal identification unit 13 starts operation and executes an abnormal-terminal identification process for identifying at least one of the four communication terminals 14 as an abnormal communication terminal (step S102). In the abnormal-terminal identification process, the abnormal-terminal identification unit 13 controls the command generation unit 11 and the bit-array change unit 12 to identify the abnormal communication terminal 14. In the abnormal-terminal identification process, a setting operation for performing normal communication by using the communication terminals 14 except the identified abnormal communication terminal 14 is also performed. After the abnormal-terminal identification process is complete, the communication is resumed in accordance with the setting (step S103).

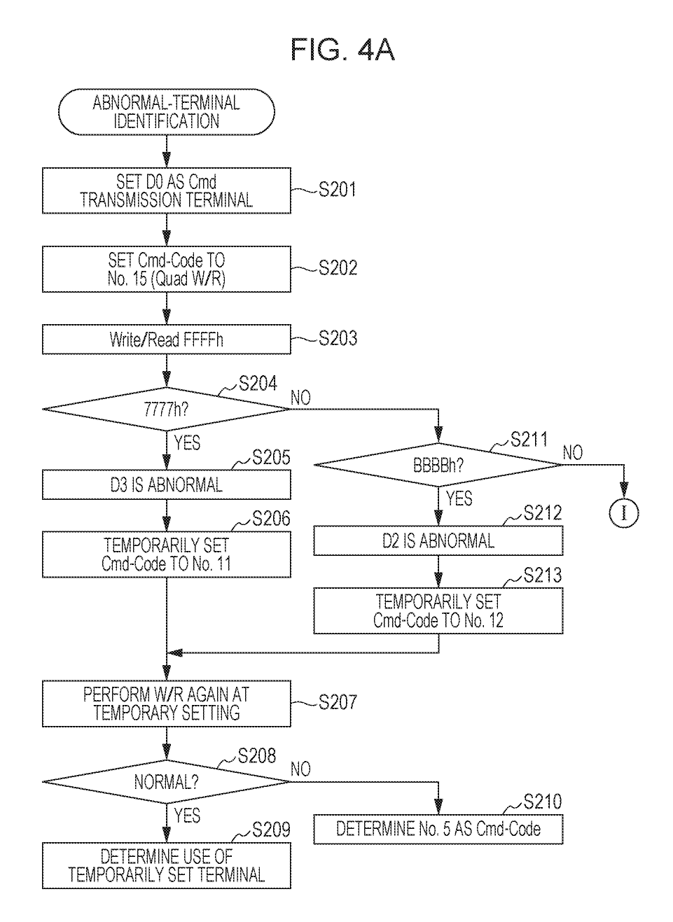

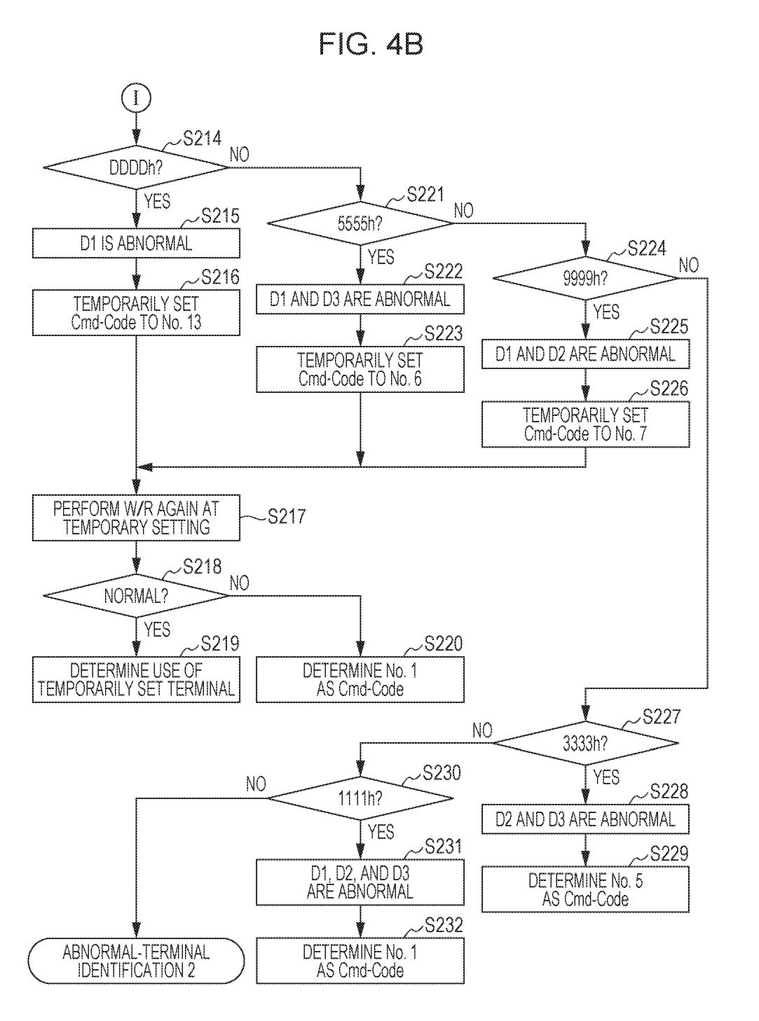

FIGS. 4A, 4B, 5, 6, and 7 are flowcharts illustrating process operations in the abnormal-terminal identification process.

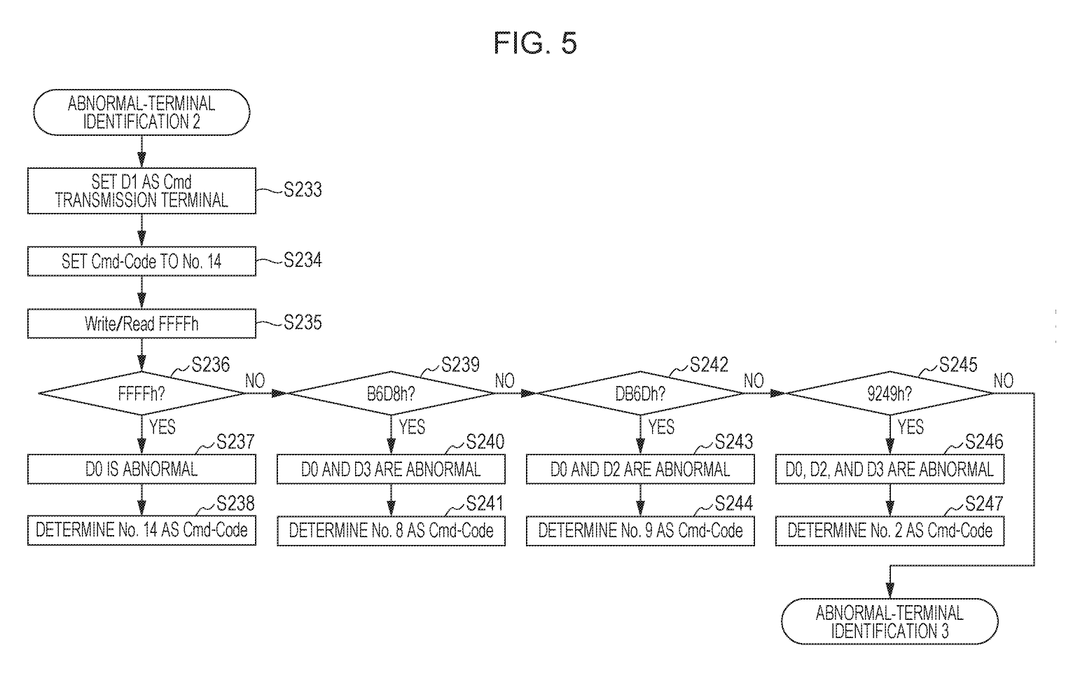

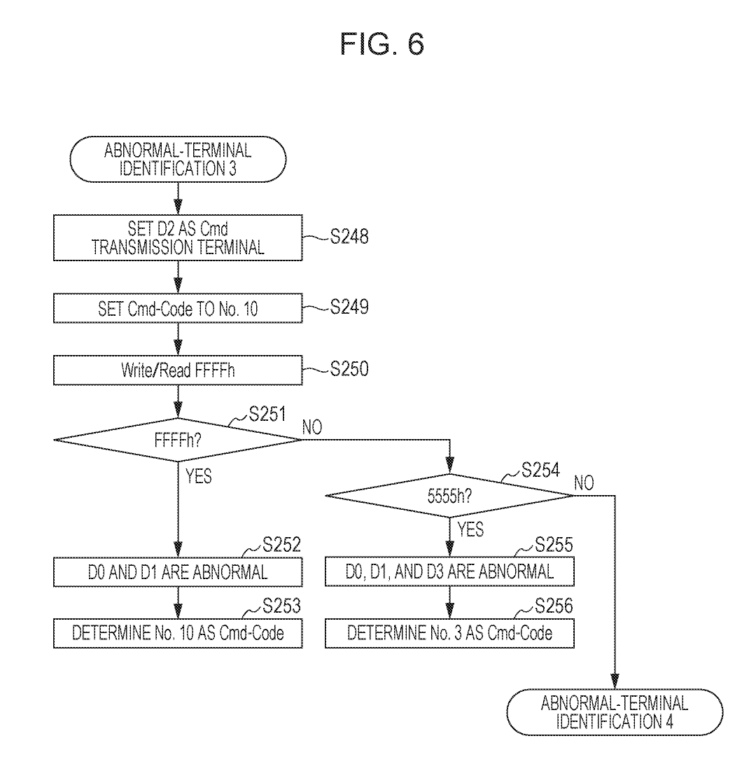

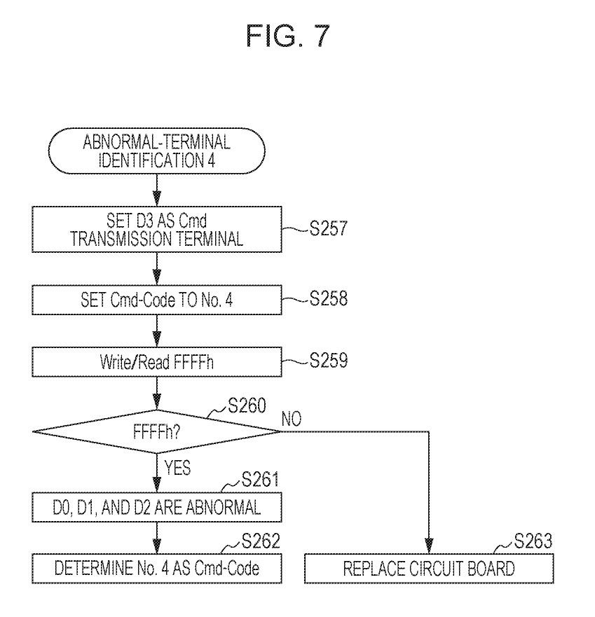

FIGS. 4A to 7 respectively illustrate the five flowcharts resulting from division of one flowchart. That is, step S211 in FIG. 4A is followed by step S214 in FIG. 4B, step S230 in FIG. 4B is followed by step S233 in FIG. 5, step S245 in FIG. 5 is followed by step S248 in FIG. 6, and step S254 in FIG. 6 is followed by step S257 in FIG. 7.

When the abnormal-terminal identification process is started, the abnormal-terminal identification unit 13 first sets a D0 terminal as a command transmission terminal for the bit-array change unit 12 (step S201). Subsequently, the abnormal-terminal identification unit 13 instructs the command generation unit 11 on transmission/reception using the No. 15 command (“Quad” command) (step S202). The abnormal-terminal identification unit 13 instructs the bit-array change unit 12 on transmission data having a hexadecimal value of “FFFF” (step S203). The command generation unit 11 and the bit-array change unit 12 that receive the instructions transmit signal bits that are sets of “1111” in binary format. Each “1” is assigned to corresponding one of the four communication terminals 14 ranging from the D0 terminal to the D3 terminal. The slave circuit 20 is then instructed to reply to the master circuit 10 by using the same signal bits.

A value of the reply from the slave circuit 20 as a result of this is checked in step S204, S211, S214, S221, S224, S227, and S230.

If the value of the reply from the slave circuit 20 (reception data) is hexadecimal “7777” (YES in step S204), the value corresponds to binary “0111011101110111”. In communication using a “Quad” command, the signal bits of the transmission/reception data are assigned, from the least significant bit, to the communication terminals in the order of the D0 terminal, the D1 terminal, the D2 terminal, the D3 terminal, again the D0 terminal, and so on. Accordingly, if the reception data is hexadecimal “7777”, a signal bit assigned to the D3 terminal for the communication exhibits a value of “0” (abnormality) (step S205). The abnormal-terminal identification unit 13 instructs the command generation unit 11 on transmission/reception using the No. 11 command (“Triple” command using the terminals other than the D3 terminal) (as a temporary setting) (step S206). The abnormal-terminal identification unit 13 causes the bit-array change unit 12 to again perform writing and reading using the hexadecimal value of “FFFF” as transmission data (step S207). If the transmission data and the reception data match as a result of this (YES in step S208), it is determined that the temporarily set No. command is to be used for subsequent communication (step S209). If the transmission data and the reception data do not match (NO in step S208), it is judged that an SPI device in the related art is used as a slave circuit, and it is determined that the No. 5 and (“Dual” command using the D0 and D1 terminals) is to be used for subsequent communication.

If the value of the reply from the slave circuit 20 (reception data) is hexadecimal “RBBB” (YES in step S211), the value corresponds to binary “1011101110111011”. Accordingly, a signal bit assigned to the D2 terminal for the communication exhibits the value of “0” (abnormality) (step S212). The abnormal-terminal identification unit 13 instructs the command generation unit 11 on transmission/reception using the No. 12 command (“Triple” command using the terminals other than the D2 terminal) (as a temporary setting) (step S213), and steps after step S207 described above are performed. As a result, the temporarily set No. 12 command or the aforementioned No. 5 command is determined as a command to be used for subsequent communication.

If the value of the reply from the slave circuit 20 (reception data) is hexadecimal “DDDD” (YES in step S214), the value corresponds to binary “1101110111011101”. Accordingly, a signal bit assigned to the D1 terminal for the communication exhibits the value of “0” (abnormality) (step S215). The abnormal-terminal identification unit 13 instructs the command generation unit 11 on transmission/reception using the No. 13 command (“Triple” command using the terminals other than the D1 terminal) (as a temporary setting) (step S216). The abnormal-terminal identification unit 13 causes the bit-array change unit 12 to perform writing and reading using the hexadecimal value of “FFFF” as transmission data (step S217). If the transmission data and the reception data match as a result of this (YES in step S218), it is determined that the temporarily set No. command is to be used for subsequent communication (step S219). If the transmission data and the reception data do not match (NO in step S218), it is judged that the SPI device in the related art is used as the slave circuit, and it is determined that the No. 1 command (“Single” command using the D0 terminal) is to be used for subsequent communication.

If the value of the reply from the slave circuit 20 (reception data) is hexadecimal “5555” (YES in step S221), the value corresponds to binary “0101010101010101”. Accordingly, signal bits respectively assigned to the D1 terminal and D3 terminal for the communication each exhibit the value of “0” (abnormality) (step S222). The abnormal-terminal identification unit 13 instructs the command generation unit 11 on transmission/reception using the No. 6 command (“Dual” command using the D0 and D2 terminals) (as a temporary setting) (step S223), and steps after step S217 described above are thereafter performed. As a result, the temporarily set No. 6 command or the aforementioned No. 1 command is determined as the command to be used for subsequent communication.

If the value of the reply from the slave circuit 20 (reception data) is hexadecimal “9999” (YES in step S224), the value corresponds to binary “1001100110011001”. Accordingly, signal bits respectively assigned to the D1 terminal and D2 terminal for the communication each exhibit the value of “0” (abnormality) (step S225). The abnormal-terminal identification unit 13 instructs the command generation unit 11 on transmission/reception using the No. 7 command (“Dual” command using the D0 and D3 terminals) (as a temporary setting) (step S226), and steps after step S217 described above are thereafter performed. As a result, the temporarily set No. 7 command or the aforementioned No. 1 command is determined as the command to be used for subsequent communication.

If the value of the reply from the slave circuit 20 (reception data) is hexadecimal “3333” (YES in step S227), the value corresponds to binary “0011001100110011”. Accordingly, signal bits respectively assigned to the D2 terminal and D3 terminal for the communication each exhibit the value of “0” (abnormality) (step S228). The abnormal-terminal identification unit 13 determines the aforementioned No. 5 command as the command to be used for subsequent communication and instructs the command generation unit 11 to use the No. 5 command (step S229).

If the value of the reply from the slave circuit 20 (reception data) is hexadecimal “1111” (YES in step S230), the value corresponds to binary “0001000100010001”. Accordingly, signal bits assigned to the three communication terminals 14 ranging from the D1 terminal to the D3 terminal for the communication each exhibit the value of “0” (abnormality) (step S231). The abnormal-terminal identification unit 13 determines the aforementioned No. 1 command as the command to be used for subsequent communication and instructs the command generation unit 11 to use the No. 1 command (step S229).

If the reception data does not match any one of the aforementioned values in the checking in steps S204, S211, S214, S221, S224, S227, and S230 (NO in step S230), the D0 terminal set as the command transmission terminal in step S201 described above is considered to have an abnormality. The process proceeds to step S233 in FIG. 5, and the abnormal-terminal identification unit 13 sets the D1 terminal as the command transmission terminal for the bit-array change unit 12. Subsequently, the abnormal-terminal identification unit 13 instructs the command generation unit 11 on transmission/reception using the No. 14 command (“Triple” command using the terminals other than the D0 terminal) (step S234). The abnormal-terminal identification unit 13 instructs the bit-array change unit 12 on writing and reading using the hexadecimal value of “FFFF” as transmission data (step S235).

A value of the reply from the slave circuit 20 as a result of this is checked in steps S236, S239, S242, and S245.

If the value of the reply from the slave circuit 20 (reception data) is hexadecimal “FFFF” (YES in step S236), the reception data matches the transmission data, and thus it is judged that only the D0 terminal is abnormal (step S237). The abnormal-terminal identification unit 13 determines the aforementioned No. 14 command as the command to be used for subsequent communication and instructs the command generation unit 11 to use the No. 14 command (step S238).

If the value of the reply from the slave circuit 20 (reception data) is hexadecimal “B6DB” (YES in step S239), the value corresponds to binary “1011011011011011”. In communication using the aforementioned No. 14 command, signal bits of the transmission/reception data are assigned, from the least significant bit, to the communication terminals in the order of the D1 terminal, the D2 terminal, the D3 terminal, again the D1 terminal, and so on. Accordingly, if the reception data is hexadecimal “B6DB”, a signal bit assigned to the D3 terminal for the communication exhibits the value of “0” (abnormality), and it is lastly judged that the D0 and D3 terminals are abnormal (step S240). The abnormal-terminal identification unit 13 determines the No. 8 command (“Dual” command using the D1 and D2 terminals) as the command to be used for subsequent communication and instructs the command generation unit 11 to use the No. 8 command (step S241).

If the value of the reply from the slave circuit 20 (reception data) is hexadecimal “DB6D” (YES in step S242), the value corresponds to binary “1101101101101101”. Accordingly, a signal bit assigned to the D2 terminal for the communication exhibits the value of “0” (abnormality), and it is lastly judged that the D0 terminal and the D2 terminal are abnormal (step S243). The abnormal-terminal identification unit 13 determines the No. 9 command (“Dual” command using the D1 and D3 terminals) as the command to be used for subsequent communication and instructs the command generation unit 11 to use the No. 9 command (step S244).

If the value of the reply from the slave circuit 20 (reception data) is hexadecimal “9249” (YES in step S245), the value corresponds to binary “1001001001001001”. Accordingly, signal bits respectively assigned to the D2 terminal and D3 terminal for the communication each exhibit the value of “0” (abnormality), and it is lastly judged that the D0 terminal, the D2 terminal, and the D3 terminal are abnormal (step S246). The abnormal-terminal identification unit 13 determines the No. 2 command (“Single” command using the D1 terminal) as the command to be used for subsequent communication and instructs the command generation unit 11 to use the No. 2 command (step S247).

If the reception data does not match any one of the aforementioned values in the checking in steps S236, S239, S242, and S245 described above (NO in step S245), each of the D0 terminal and the D1 terminal is considered to have an abnormality. The process thus proceeds to step S248 in FIG. 6, and the abnormal-terminal identification unit 13 sets the D2 terminal as the command transmission terminal for the bit-array change unit 12. The abnormal-terminal identification unit 13 instructs the command generation unit 11 on transmission/reception using the No. 10 command (“Dual” command using the D2 and D3 terminals) (step S249). The abnormal-terminal identification unit 13 instructs the bit-array change unit 12 on writing and reading using the hexadecimal value of “FFFF” as transmission data (step S250).

A value of the reply from the slave circuit 20 as a result of this is checked in steps S251 and S254.

If the value of the reply from the slave circuit 20 (reception data) is hexadecimal “FFFF” (YES in step S251), the reception data matches the transmission data, and it is thus judged that the D0 terminal and the D1 terminal are abnormal (step S252). The abnormal-terminal identification unit 13 determines the aforementioned No. 10 command as the command to be used for subsequent communication and instructs the command generation unit 11 to use the No. 10 command (step S253).

If the value of the reply from the slave circuit 20 (reception data) is hexadecimal “5555” (YES in step S254), the value corresponds to binary “0101010101010101”. Accordingly, a signal bit assigned to the D3 terminal for the communication exhibits the value of “0” (abnormality), and it is judged that the D0 terminal, the D1 terminal, and the D3 terminal are abnormal (step S255). The abnormal-terminal identification unit 13 determines the No. 3 command (“Single” command using the D2 terminal) as the command to be used for subsequent communication and instructs the command generation unit 11 to use the No. 3 command (step S256).

If the reception data does not match any one of the aforementioned values in the checking in steps S251 and S254 (NO in step S254), each of the communication terminals that are the D0, D1 , and D2 terminals is considered to have an abnormality. The process thus proceeds to step S257 in FIG. 7, and the abnormal-terminal identification unit 13 sets the D3 terminal the command transmission terminal for the bit-array change unit 12. The abnormal-terminal identification unit 13 instructs the command generation unit 11 on transmission/reception using the No. 4 command (“Single” command using the D3 terminal) (step S258). The abnormal-terminal identification unit 13 instructs the bit-array change unit 12 on writing and reading using the hexadecimal value of “FFFF” as transmission data (step S259).

If the value of the reply from the slave circuit 20 (reception data) is hexadecimal “FFFF” as a result of this (YES in step S260), the reception data matches the transmission data, and it is thus judged that the D0 to D2 terminals other than the D3 terminal are abnormal (step S261). The abnormal-terminal identification unit 13 determines the aforementioned No. 4 command as the command to be used for subsequent communication and instructs the command generation unit 11 to use the No. 4 command (step S262).

If the value of the reply from the slave circuit 20 (reception data) is not hexadecimal “FFFF” (NO in step S260), all of the four communication terminals 14 are considered to be abnormal or a device in the related art that allows only the D0 terminal to be set as the command transmission terminal is considered to be used as the slave circuit, and the abnormal-terminal identification unit 13 thus outputs an error notification suggesting replacement of a circuit board (step S263).

With the abnormal-terminal identification process described above, one or more abnormal ones of the four communication terminals 14 are identified, and communication using the communication terminals 14 other than the one or more abnormal communication terminals 14 is set to continue the communication. In the first exemplary embodiment, even if the slave circuit has a structure in the related art, the abnormal terminal is identifiable by the master circuit, and the first exemplary embodiment has a wide application range. Note that the abnormal-terminal identification unit 13 is included in the master circuit 10 in the description of the first exemplary embodiment but may be externally provided for the existing master circuit 10.

Subsequently, a second exemplary embodiment will be described.

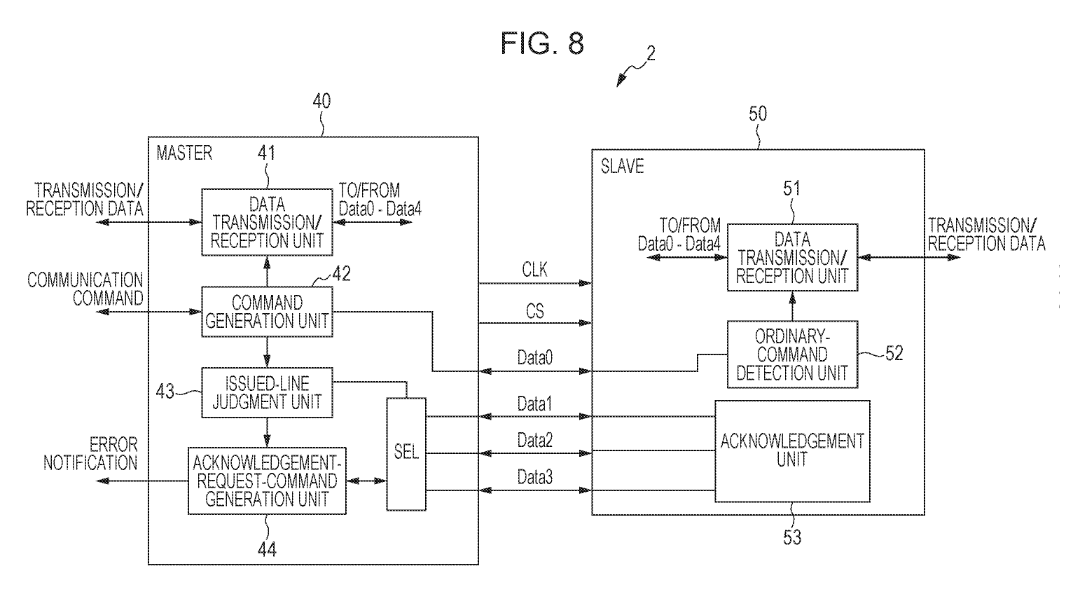

FIG. 8 is a diagram schematically illustrating the configuration of a communication system 2 including a communication device according to the second exemplary embodiment.

The communication system 2 also performs the SPI communication. The communication system 2 includes a master circuit 40 and a slave circuit 50. The master circuit 40 includes a data transmission/reception unit 41, a command generation unit 42, an issued-line judgment unit 43, an acknowledgement-request-command generation unit 44, multiple (herein four, for example) communication terminals 45, and a selector 46. The slave circuit 50 includes a data transmission/reception unit 51, an ordinary-command detection unit 52, and an acknowledgement unit 53.

The communication terminals 45 of the master circuit 40 are connected to the slave circuit 50, and the master circuit 40 communicates with the slave circuit 50 via the communication terminals 45 to exchange commands and data. Although FIG. 8 also illustrates the one slave circuit 50, multiple slave circuits 50 may be connected to the one master circuit 40. The slave circuit 20 illustrated in FIG. 1 may also be connected to the master circuit 40.

Also in the second exemplary embodiment, the master circuit 40 transmits, to the slave circuit 50, a clock signal CLK for synchronizing communication and a chip select signal CS for selecting one of the slave circuits 50.

In response to an instruction for communication, the command generation unit 42 of the master circuit 40 generates a command. The command generation unit 42 inputs the command into the data transmission/reception unit 41 and also transmits the command to the slave circuit 50 via the D0 terminal among the communication terminals 45.

The data transmission/reception unit 41 of the master circuit 40 exchanges transmission/reception data with another circuit in a device such as a CPU including the master circuit 40. The data transmission/reception unit 41 assigns transmission/reception data to at least one of the four communication terminals 45 that is used in accordance with the command input from command generation unit 42.

In the communication system 2 in FIG. 8, aside from ordinary communication commands, an acknowledgement request command for requesting the slave circuit 50 for an acknowledgement is provided as a command for checking an abnormality of a communication terminal.

The issued-line judgment unit 43 of the master circuit 40 checks for an ordinary communication command generated by the command generation unit 42 and thereby judges which of the communication terminals 45 is to be used as the at least one of the communication terminals 45 that is to be used in the ordinary communication. The issued-line judgment unit 43 determines one of the communication terminals 45 that is not used in the ordinary communication as the communication terminal 45 for issuing an acknowledgement request command and causes the selector 46 to select the determined communication terminal 45.

The acknowledgement-request-command generation unit 44 transmits the acknowledgement request command to the slave circuit 50 via the communication terminal 45 determined by the issued-line judgment unit 43 and selected by the selector 46. The acknowledgement-request-command generation unit 44 also judges whether an acknowledgement is acquired from the slave circuit 50 in response to the acknowledgement request command. If the acknowledgement is not acquired, the acknowledgement-request-command generation unit 44 outputs an error notification.

The ordinary-command detection unit 52 of the slave circuit 50 detects the ordinary communication command received from the master circuit 40 and thereby identifies at least one of the communication terminals 45 as a communication terminal to be used in this time communication. The ordinary-command detection unit 52 notifies the data transmission/reception unit 51 of the identified communication terminal 45.

The data transmission/reception unit 51 of the slave circuit 50 performs transmission/reception data communication by using the communication terminal 45 notified of from the ordinary-command detection unit 52 and exchanges the transmission/reception data with another circuit in a device including the slave circuit 50.

The acknowledgement unit 53 of the slave circuit 50 detects the acknowledgement request command transmitted from the master circuit 40 and transmits an acknowledgement in response to the acknowledgement request command.

The combination of the command generation unit 42 and the data transmission/reception unit 41 of the master circuit 40 corresponds to an example of the communication unit, the four communication terminals 45 each correspond to an example of the corresponding one of the multiple communication terminals, and the acknowledgement-request-command generation unit 44 corresponds to an example of the combination of the abnormality identification unit and the communication controller.

Subsequently, the operation steps for identifying an abnormal communication terminal 45 in the communication system 2 in FIG. 8 will be described. Also when needing to be discriminated from each other in the following description, the four communication terminals 45 are referred to as the D0 terminal, the D1 terminal, the D2 terminal, and the D3 terminal.

In the communication system 2 in FIG. 8, the slave circuit 50 of the type illustrated in FIG. 8 or a device in the related art without the acknowledgement unit 53 is connectable as a slave circuit as described above. Accordingly, to identify an abnormal communication terminal 45, the command generation unit 42 and the data transmission/reception unit 41 execute an “abnormality judgment sequence”, and the issued-line judgment unit 43 and the acknowledgement-request-command generation unit 44 execute a “D1-D3 terminal judgment sequence”. Not only the abnormal-terminal identification but also slave-circuit type judgment is performed.

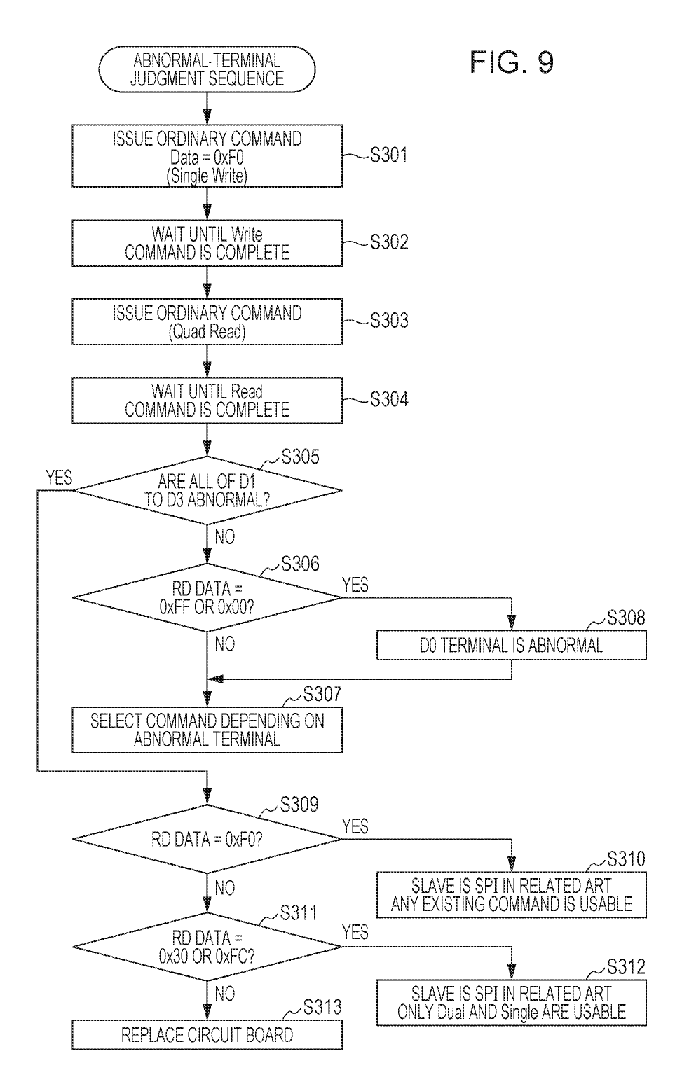

FIG. 9 is a flowchart illustrating operation steps in the abnormality judgment sequence.

After the abnormality judgment sequence is started, the command generation unit 42 generates the ordinary command for “Single” writing using the D0 terminal, and a hexadecimal value of “0xF0” is designated as transmission data (step S301). Thereafter, the process waits until the data transmission/reception unit 41 completes the data transmission (writing to the slave circuit 50) (step S302).

After the writing is complete, the command generation unit 42 generates an ordinary command for “Quad” reading (step S303). The process waits until the data transmission/reception unit 41 completes the data reception (reading from the slave circuit 50) (step S304).

In parallel with the data transmission/reception in the ordinary communication in the abnormality judgment sequence as described above, the “D1-D3 terminal judgment sequence” is executed.

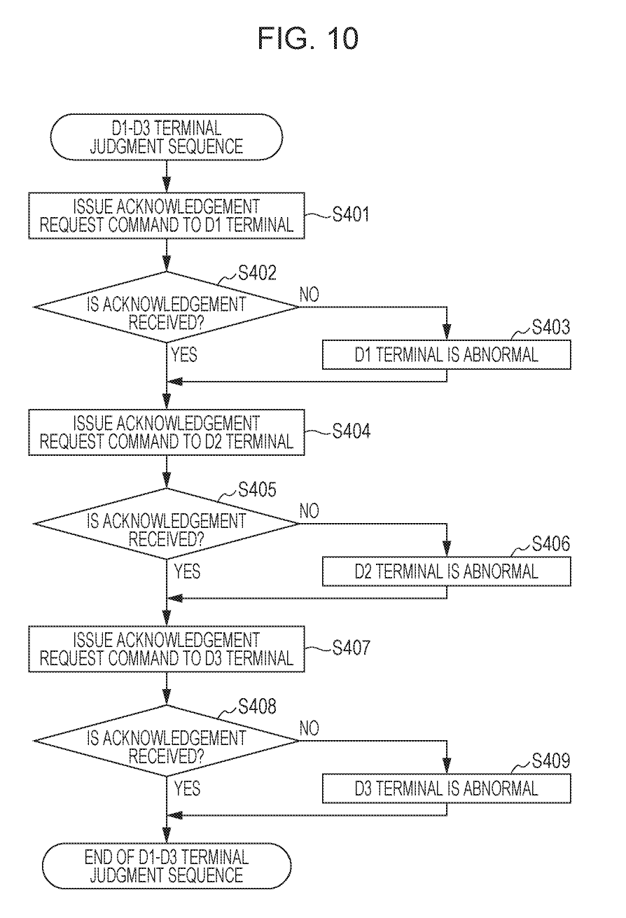

FIG. 10 is a flowchart illustrating the operation steps in the D1-D3 terminal judgment sequence.

Before the D1-D3 terminal judgment sequence is started, the issued-line judgment unit 43 judges that the communication terminal designated in the command generated in step S301 in FIG. 9 is only the D0 terminal. In the D1-D3 terminal judgment sequence, the three communication terminals ranging from the D1 terminal to the D3 terminal are checked for abnormality in the following manner in parallel with the transmission/reception in steps S301 to S304 in FIG. 9.

The selector 46 selects the D1 terminal in accordance with an instruction from the issued-line judgment unit 43, and the acknowledgement-request-command generation unit 44 issues an acknowledgement request command to the D1 terminal (step S401). The acknowledgement-request-command generation unit 44 judges whether an acknowledgement is received from the D1 terminal (step S402). If the acknowledgement is not received (NO in step S402), the D1 terminal is judged to be abnormal (step S403). By using the acknowledgement in this manner, whether the communication terminal is abnormal or normal is correctly judged in simple steps.

The selector 46 selects the D2 terminal in accordance with an instruction from the issued-line judgment unit 43, and the acknowledgement-request-command generation unit 44 issues an acknowledgement request command to the D2 terminal (step S404). The acknowledgement-request-command generation unit 44 judges whether an acknowledgement is received from the D2 terminal (step S405). If the acknowledgement is not received (NO in step S405), the D2 terminal is judged to be abnormal (step S406).

The selector 46 selects the D3 terminal in accordance with an instruction from the issued-line judgment unit 43, the acknowledgement-request-command generation unit 44 issues an acknowledgement request command to the D3 terminal (step S407). The acknowledgement-request-command generation unit 44 judges whether an acknowledgement is received from the D3 terminal (step S408). If the acknowledgement is not received (NO in step S408), the D3 terminal is judged to be abnormal (step S409).

Results of the judgments of whether the communication terminals are abnormal or normal obtained in the D1-D3 terminal judgment sequence are transmitted to the command generation unit 42 to be used in the abnormality judgment sequence.

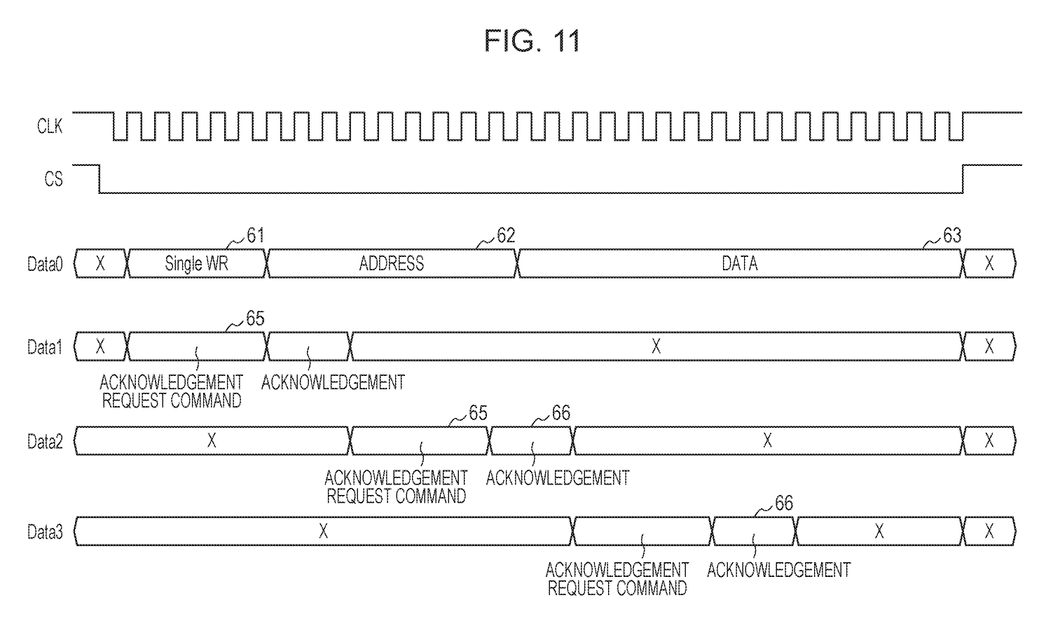

FIG. 11 is a timing chart illustrating example operation timing in the D1-D3 terminal judgment sequence.

FIG. 11 illustrates the clock signal CLK and the chip select signal CS that are described above and further illustrates signals Data0, Data1, Data2, and Data3 respectively observed at the D0 terminal, the D1 terminal, the D2 terminal, and the D3 terminal.

The D0 terminal is used to exchange a command 61, an address 62 for reading data, and data 63 in ordinary communication performed by the command generation unit 42 and the data transmission/reception unit 41 of the master circuit 40. Since the “Single” command using the D0 terminal is used in this example, the D1 to D3 terminals are not used in the ordinary communication. Accordingly, the three communication terminals from the D1 terminal to the D3 terminal are used to exchange an acknowledgement request command 65 and an acknowledgement 66, while the D0 terminal is being used to exchange the command 61, the address 62, and the data 63. Commands for checking abnormalities in the communication terminals and replies are exchanged in this manner in parallel with the ordinary communication. This eliminates the need for providing an additional time for confirmation and is efficient.

Referring back to FIG. 9, the description is continued.

After the transmission/reception in steps S301 to S304 in FIG. 9 are complete, the command generation unit 42 acquires the results of the judgments of whether the communication terminals are abnormal or normal that are obtained in the D1-D3 terminal judgment sequence, and it is judged whether the judgment results indicate abnormalities in all the three communication terminals from the D1 terminal to the D3 terminal (step S305). If at least one of the communication terminals is judged to be normal (NO in step S305), it is understood that the slave circuit 50 of the type illustrated in FIG. 8 is used as the slave circuit. In this case, to check whether the D0 terminal that has not been judged in the D1-D3 terminal judgment sequence is normal or abnormal, it is judged whether the read data0 obtained in step S104 described above has a hexadecimal value of “0xFF” or a hexadecimal value of “0x00” (step S306). If the read data has neither the hexadecimal value of “0xFF” nor the hexadecimal value of “0x00” (NO in step S306), the D0 terminal is considered to be normal, and a command using the one or more communication terminals other than the one or more communication terminals judged to be abnormal in the D1-D3 terminal judgment sequence is selected in the same manner as in the aforementioned first exemplary embodiment (step S307). As a result, even if at least one of the communication terminals is abnormal, communication is continued by using the other normal communication terminals.

If the read data has the hexadecimal value of “0xFF” or the hexadecimal value of “0x00” (YES in step S306), the D0 terminal is judged to be also abnormal (step S308). As a result, a command using one or more communication terminals other than the D0 terminal and the one or more communication terminals judged to be abnormal in the D1-D3 terminal judgment sequence is selected in step S307.

If the results of the judgments of whether the communication terminals are abnormal or normal that are obtained in the D1-D3 terminal judgment sequence indicate that all the three communication terminals from the D1 terminal to the D3 terminal are abnormal (YES in step S305), there is a probability that the device in the related art without the acknowledgement unit 53 is used as the slave circuit. Hence, it is judged whether the read data obtained in step S304 described above has the hexadecimal value of “0xF0” (step S309). If the read data has the hexadecimal value of “0xF0” (YES in step S309), the read data that is the same as the write data is obtained. Accordingly, it is determined that the device in the related art without the acknowledgement unit 53 is used as the slave circuit and that all of the ordinary commands illustrated in FIG. 2 are usable (step S310).

If the read data does not have the hexadecimal value of “0xF0” (NO in step S309), it is judged whether the read data has a hexadecimal value of “0x30” or a hexadecimal value of “0xFC” (step S311). If the read data has the hexadecimal value of “0x30” or the hexadecimal value of “0xFC” (YES in step S311), it is judged that the device in the related art without the acknowledgement unit 53 is used as the slave circuit and that the D2 terminal or the D3 terminal is abnormal, and it is determined that only the “Dual” and “Single” commands are usable (step S312). Note that a specific command is determined in accordance with one or more abnormal communication terminals in the same manner as in the first exemplary embodiment, and detailed description is herein omitted.

If the read data has neither the hexadecimal value of “0x30” nor the hexadecimal value of “0xFC”, it is not judged that a normal communication terminal is present, and the acknowledgement-request-command generation unit 44 outputs the error notification suggesting the replacement of the circuit board (step S313).

Once the abnormality judgment sequence and the D1-D3 terminal judgment sequence that are described above are executed, each abnormal terminal and the type of the slave circuit are identified. If the identified type of the slave circuit is the type of the slave circuit in the related art, the abnormality judgment sequence and the D1-D3 terminal judgment sequence do not need to be executed again. If the slave circuit 50 of the type illustrated in FIG. 8 is used as the slave circuit, the abnormality judgment sequence and the D1-D3 terminal judgment sequence are repeated at predetermined intervals to thereby monitor an aging failure of the communication terminals.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication device comprising:
a plurality of communication terminals connected to a different communication device;
a communication unit that performs communication with the different communication device via the communication terminals, the communication unit using a plurality of communication settings each of which differently uses at least one of the communication terminals in the communication;
an abnormality identification unit that identifies at least one of the plurality of communication terminals that is abnormal in the communication; and
a communication controller that causes the communication unit to perform the communication by using one of the communication settings that uses at least one of the plurality of communication terminals other than the at least one communication terminal identified by the abnormality identification unit.

2. The communication device according to claim 1,
wherein the abnormality identification unit causes the communication unit to receive known data from the different communication device by using the plurality of communication terminals, and the abnormality identification unit identifies, as an abnormal communication terminal, at least one of the communication terminals that is assigned to one of communication bits that is different between actually received data and the known data.

3. The communication device according to claim 1,
wherein the different communication device transmits an acknowledgement in response to a request for the acknowledgement, and
wherein the abnormality identification unit transmits the request to the different communication device, and the abnormality identification unit identifies, as an abnormal communication terminal, at least one of the communication terminals that experiences a failure to transmit the acknowledgement in response to the request.

4. The communication device according to claim 3,
wherein the abnormality identification unit transmits the request during the communication by using at least one of the communication terminals that is not used for the communication performed by the communication unit, and the abnormality identification unit receives the acknowledgement.

5. A communication method comprising:
performing communication between a communication device and a different communication device via a plurality of communication terminals connected between the communication device and the different communication device, the communication being performed by using a plurality of communication settings each of which differently uses at least one of the communication terminals in the communication;
identifying at least one of the plurality of communication terminals that is abnormal in the communication; and
performing the communication by using one of the communication settings that uses at least one of the plurality of communication terminals other than the at least one identified communication terminal.
